(19) United States
(12) Patent Application Publication
(10) Pub. No.: US 2012/0250870 A1
(43) Pub. Date: Oct. 4, 2012

(54) CALIBRATING A PUBLIC ADDRESS INSTALLATION

(75) Inventor: Christner Matthias, Ludwigsburg (DE)

(73) Assignee: d&b audiotechnik GmbH, Backnang (DE)

(21) Appl. No.: 13/431,122

(22) Filed: Mar. 27, 2012

(30) Foreign Application Priority Data
Mar. 28, 2011 (DE) 10 2011 001 605.8

(51) Int. Cl. H04R 27/00; H04R 29/00

(52) U.S. Cl. 381/58

(57) ABSTRACT

A method for calibrating a public address installation comprising simulation of a public address system based on simulation parameters is provided. The public address system may comprise the public address installation and an auditorium. A simulation may deliver configuration parameters for the public address installation. The public address installation may be configured using the delivered configuration parameters, for example. The public address installation may be operated, and acoustic measurements may be taken in the auditorium. The simulation parameters may be customized based on measurement results from the acoustic measurements in order to reduce a discrepancy between simulation results and measurement results for the public address system.

### RELATED APPLICATION

This application claims priority to German Application No. 10 2011 001 605.8, filed on Mar. 28, 2011, entitled “CALIBRATING A PUBLIC ADDRESS INSTALLATION”, at least some of which may be incorporated herein.

### BACKGROUND

This application relates to a method and/or a computer program for calibrating a public address installation.

Public address installations of a certain order of magnitude or complexity may be customized to suit a space to be covered by virtue of a suitable arrangement of the installation parts and/or sonic adjustments in order to attain tonally impeccable sound throughout an auditorium. The planning and calibration of a public address installation may be performed by specialists using software and acoustic measurements and may require a large amount of experience from persons commissioned to do so.

However, in many cases, discrepancies between a public address installation setup and real circumstances of an auditorium from the planning principles may result in maladjustments. To this end, complex realignment of the public address installation may be beneficial. In the case of large events, (e.g. public address for stadium), this realignment may drag on for days and may be associated with high levels of cost.

### SUMMARY

Simulation parameters may be customized based on measurement results from acoustic measurements in the field. Accordingly, simulation parameters forming the basis for the simulation may be altered or realigned using measurements. This may be done by an interface between the acoustic measurement data program for performing the acoustic measurements in the auditorium and the simulation data program and can be performed automatically, such as during the measurement process, for example.

### BRIEF DESCRIPTION OF THE DRAWINGS

The subject matter herein is explained by way of example below using exemplary embodiments with reference to the drawings, in which:

FIG. 1 is a schematic illustration for calibrating a public address installation in accordance with an exemplary embodiment;

FIG. 2 is a schematic illustration for calibrating a public address installation in accordance with an exemplary embodiment;

FIG. 3 is a schematic illustration for calibrating a public address installation having a subwoofer array in accordance with an exemplary embodiment;

FIG. 4 is a flow diagram for calibrating a public address installation for frequency response optimization in accordance with an exemplary embodiment;

FIG. 5 is a flow diagram for calibrating a public address installation for propagation time customization in accordance with an exemplary embodiment.

### DETAILED DESCRIPTION

Design and calibration of a public address installation may be facilitated (e.g., in three phases) by software:

In a first phase comprising planning, depending on the complexity of the software used and the demands on the planning, a simple case may involve at least the audience areas—if demands are high, entire spaces may be modelled. A piece of simulation software may be used to simulate relevant variables (e.g., such as level distribution based on frequency, reverberation response, through to measures of intelligibility). The simulation results may be used to select a suitable public address system, optimize the positioning and orientation thereof, and/or ascertain adjustments to be expected and/or necessary corrections in signal processing for individual sources.

In a second phase comprising control, (e.g., during the design or start-up) of a public address installation, a piece of network-assisted control software may be used to check the correct operation of installation parts and/or to adjust respectively desired configurations.

In a third phase comprising calibration, a piece of acoustic measurement software may be used to take measurements for the relevant installation parts and/or groups at different suitable positions. These measurements may be evaluated in a suitable manner and corrections and/or adjustments may be transmitted to relevant installation parts using control software and/or a control network. By way of example, the adjustments may influence the frequency response based on equalizers and producing suitable time-based sound propagation conditions by adjusting delays in the channels which drive the loudspeakers.

Simulation of a public address system may be used upwards of a certain order of magnitude and/or complexity. Complexity may be understood both to mean the number and spatial distribution of a plurality of sources and/or to mean system variability in relation to a variably adjustable radiation characteristic by virtue of appropriately suitable individual driving and/or orientation of a plurality of sources within a system or array complex.

Simulation and control software may be connected in different forms and/or depths. By way of example, a user interface for control software may be created from the planning software. To this end, the level of configuration of the overall installation or individual parts thereof and functional groups which is achieved in the simulation may be created as a useful interface with appropriate groupings within the control software.

In addition, adjustment parameters for functional groups already approximated in the simulation may be transferred to the control software and transmitted to respective appliances after the connection to the real installation is set up. By way of example, connection of simulation software to control software may allow a radiation simulation for the source to be achieved with transfer of adjustment values to the control software. Further, automatic generation of optimized DSP (Digital Signal Processor) coefficient sets for every single source involved in a functional group in the case of a line array may be contemplated.

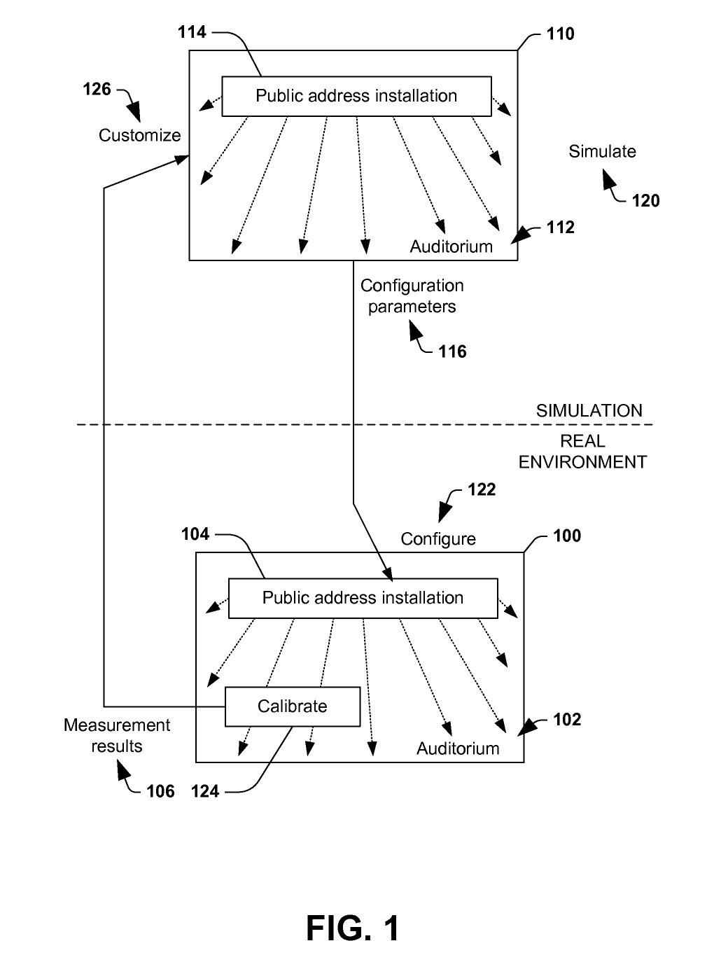

FIG. 1 illustrates a schematic illustration for calibrating a public address installation in accordance with an exemplary embodiment. A method may comprise simulating 120 a public address system 110 comprising an auditorium 112 and a public address installation 114. A real environment portion of FIG. 1 illustrates a real environment with a real public address system 100 comprising a real auditorium 102, (such as a theatre, a concert hall, a stadium, and/or an audience space, for example) and the real public address installation 104, (e.g., a loudspeaker installation comprising a plurality of loudspeakers, such as line arrays and/or bass arrangements (subwoofers)). The simulation portion of FIG. 1 illustrates the simulation of the real environment and a simulated public address system 110 comprising a simulated auditorium 112 and a simulated public address installation 114.

In this context, the auditorium may be understood generally to mean not only a closed space but also open spaces, such as open air events, which in theory may be of infinite size, for example. Thus, the public address system 100 may be used for large events (e.g., public addresses for stadiums).

The public address system 100 may be simulated 120 based on simulation parameters which, by way of example, may comprise dimensions of the auditorium 102 and/or geometric configuration variables for the public address installation 104, such as dimensions or distances for installation parts of the public address installation, for example. It may be possible for the public address installation 104 to be adjusted or configured, using configuration parameters 116. Configuration parameters 116 may be adjustment variables for the public address installation 104 and may be used to produce a particular distribution of sound in the auditorium 102.

The distribution of sound in the auditorium 102 may be provided both by spatial properties of the auditorium, such as the volume, shape, absorption properties of the different surface materials, etc., and may be further influenced by properties of the public address installation (e.g., frequency-dependent level distribution, source localization, and/or intelligibility, for example). The term “acoustics” may be understood in a similar manner, (e.g., determined not only by the properties of the auditorium, such as the “room acoustics”, but also by the properties of the public address installation (naturally in optimum fashion with clever utilization of the predetermined room acoustics)).

By way of example, the configuration parameters 116 may be adjustments for the amplifiers of the individual sound sources in the public address installation 104, for example sound level, frequency dependency, time offset relative to one another. They may also be equalizer coefficients for an upstream mixing desk, a channel-dependent equalizer, DSP, or mechanical adjustments for the individual loudspeaker cabinets (e.g., height above the ground, distance from one another, angle of orientation relative to one another or relative to a reference position, radiation angle, and/or radiation orientation).

The simulation, (e.g., Simulate 120), may provide simulation results which may be used to select a suitable simulated public address installation 114 and to ascertain configuration parameters 116 for the installation 114. The simulation result output may be a frequency-dependent level distribution, an impulse response, a reverberation response, and/or measures of intelligibility, for example.

In a second act 122, the real public address installation 104 may be configured using the configuration parameters 116 delivered by the simulation, for example. The public address installation 104 may be configured electrically, mechanically, and/or manually. By way of example, the configuration may be implemented using a control program to load DSP coefficients into signal processors which execute the channel-dependent signal processing for the amplifiers and/or equalizers. To this end, the configuration may be connected upstream of the loudspeakers (e.g., sound sources). By way of example, the control program may be used to perform mechanical driving operations for the sound sources, such as altering the orientation in the loudspeaker complex, repositioning loudspeakers, and/or changing the angle of inclination, (e.g., by driving electric motors, for example). In another embodiment, manual orientation may be implemented based on stage personnel altering the distance between two loudspeaker systems and/or individual sound sources. For example, a loudspeaker system may be setup by correcting an error in the cabling (e.g., via a polarity reversal and/or cable transposition for different sound sources).

In a third act 124, the public address installation 104 may be calibrated. The measurement results 106 ascertained may be a frequency-dependent level distribution, an impulse response, and/or a reverberation response or measures of intelligibility, for example.

In a fourth act 126, the simulation 120 may be customized based on measurement results 106 from the calibration 124 in order to reduce a discrepancy between simulation results from the simulated public address system 110 and measurement results 106 from the real public address system 100. The simulation 120 may be customized 126 by changing simulation parameters based on measurement results 106. Customization may thus deliver configuration parameters 116 for simulation results from the simulated public address system 110 to suit the measurement results 106 from the real public address system 100. Accordingly, the simulated public address system 110 may be customized to suit the real public address system 100 and the simulation may be performed in a more precise manner than without such measurement results 106. By way of example, it may be possible to use actual distances and/or orientations of sound sources, ascertained by propagation time measurements (e.g., instead of using nominal distances and/or orientations from the simulation parameters). Therefore, the model on which the simulation is based may be approximated to reality, for example. It may be possible to account for finer points of the auditorium 102, such as supporting pillars and/or particular spatial characteristics (e.g., which were not present in the simulated public address system), for example.

The calibration may involve acoustic measurements, for example. By way of example, the acoustic measurements may be used to verify positions of the sources and/or the correct cabling thereof for an intended amplifier and signal processing channel. To this end, single sources may be switched on individually in succession and auditioned manually, (e.g., by employing several persons). In addition, equalizer settings may be ascertained for individual sources and/or groups of sources. This may be done by measuring a plurality of positions in a target area for a source (e.g., group). In one example, between approximately 1 and approximately 40 positions, averaging the results may provide a particular (e.g., average) frequency response. The selection of measurement points may be dependent on configuration of the installation and/or the sub-installation and may be based on experience of a person selecting the measurement points. This selection of representative measurement points is generally not trivial. In addition, appropriate compensating adjustments for the absorption of the air may be ascertained. Molecular energy absorption effects provide that air may attenuate at high frequencies in the audio band, in addition to purely distance-dependent level reduction. This effect may be dependent on frequency, temperature, humidity, and/or distance, and may be taken into account in simulations, but usually on the basis of very broad assumptions regarding the atmospheric conditions.

Calibration may be based on a method according to the disclosure, for example, based on the embodiment shown in FIG. 1, the calibration may have an interaction with the simulation. By way of example, a measurement program may interact with a simulation program and execute a method to propose suitable measurement points at which measurements may be actually performed. In addition, if the points which are in turn suitable, it may be possible to determine a match of greater or lesser quality with simulation results, so that further measurements in the series possibly become unfounded. In a stadium, for example, this may provide a substantial time saving in the order of days.

The acoustic start-up may involve suitable delay times for installation parts of the public address installation (e.g., ascertaining “time alignment” during calibration). To this end, an “alignment strategy” customized to suit the situation, (e.g., the spatial positioning of the installation parts), may be defined in order to attain desired source localization (e.g., of the stage) and echo-free sound over a broad range for target areas. Echo-free generally means reducing sound from signals of a similar level and a greater time offset. Installation parts may be delayed internally in order to attain a particular overall radiation. Associated information may be available in the simulation program. Thus, it may be possible to propose a suitable strategy and suitable measurement positions based on the simulation program information. A number of measurements may become unfounded as a result of a match being found between simulation and measurement. A match between the positions on which the simulation is based and the real positions may be verified, for example.

The selection of suitable measurement points may be “iterative”. By way of example, measurements may be taken to find a position at which two subsystems “time alignment” may be adjusted to deliver a same level in a relevant frequency range. This may be ascertained in the simulation program, for example, and proposed as a suitable point or a suitable axis.

Measurement positions may be adopted more than once. If a measurement position has already been chosen for ascertaining a frequency response adjustment, the same measurement position may be suitable for performing an alignment adjustment for a subsystem. A method may be implemented via a “guided measurement procedure”. The method (e.g., a program) could advise the user that respective suitable positions could be used to take measurements and automatically perform adjustments to the public address installation and/or to individual components of the installation (e.g., such as by muting installation parts which may not be required and/or interfere with the measurements).

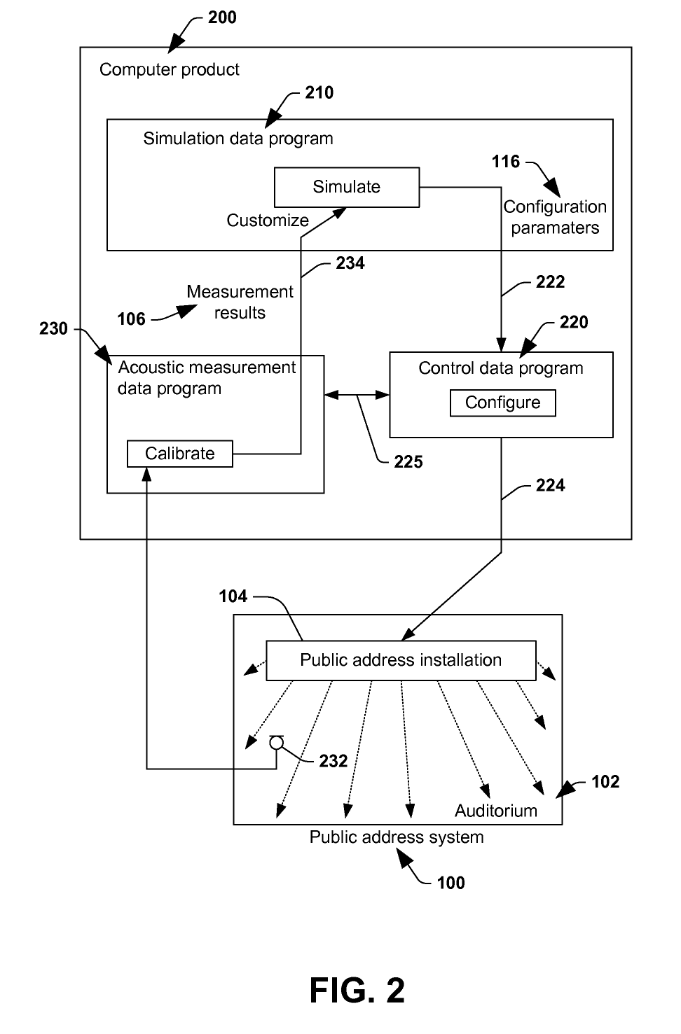

FIG. 2 illustrates a schematic illustration of a computer program product for calibrating a public address installation in accordance with an exemplary embodiment. The computer program product 200 may comprise a simulation data program 210, a control data program 220, and an acoustic measurement data program 230. The computer program product 200 may be used to calibrate a public address installation 104 in a public address system 100, which may comprise an auditorium 102. The public address system 100 may correspond to the public address system 100 shown in FIG. 1. The simulation data program 210 may be used to simulate the public address system 100, and deliver configuration parameters 116 for the public address installation 104 in the public address system 100. The configuration parameters 116 may correspond to the configuration parameters 116 of FIG. 1. Simulation 120 shown in FIG. 1 may be performed using the simulation program 210.

The control data program 220 may be used to configure the public address installation 104 using the delivered configuration parameters 116. Control data program 220 may receive simulation data from simulation data program 210 via a control data interface 222. To this end, the control data program 220 may comprise a configuration data interface 224 to the public address installation 104. In one embodiment, a DSP interface may be provided, in order to load new DSP coefficients into the public address installation 104. The acoustic measurement data program 230 may be used to calibrate the public address installation 104 in the public address system 100. Public address system 100 may be connected to one or more microphones 232 and/or acoustic measured value pickups in the auditorium 102, in order to pick up acoustic parameters from the public address system 100 (e.g., as already described in relation to the method shown in FIG. 1). Measurement results 106 from the acoustic measurement data program 230 or information may be based on measurement results transmitted via a measurement data interface 234 to the simulation data program 210. Additionally, simulation data program 210 may take these measurement results 106 as a basis for customizing the simulation of the public address system 100 (e.g., the simulation parameters on which the simulation is based, in order to reduce a discrepancy between simulation results from the public address system 100 and measurement results 106 from the public address system 100).

The computer program product 200 and/or the individual modules thereof, (e.g., the simulation data program 210, the control data program 220, and the acoustic measurement data program 230), may be stored as application software on a data storage medium and/or in the network for the purpose of downloading to the computer or may be installed on a computer as an executable data processing program thereon. The computer program product 200 may be accommodated inside the auditorium 102 or outside the auditorium 102.

FIG. 2 illustrates two interfaces 234 and 222 which may provide a connection to the simulation data program 210. It will be appreciated that the functional processes and data transfers of FIG. 2 may be implemented in different ways. By way of example, the acoustic measurement data program 230 and the control data program 220 may be implemented as coupled program modules which communicate via data interchange and may be in contact with the simulation data program 210 via a common interface (e.g., corresponding to the interfaces 234 and 222). In particular, it may be possible for the control data program to perform the control of the public address installation 104 via the interface 224 in the form of transmission of configuration data and flow control for the measurements, (such as start-up of the public address installation, which takes place as part of the measurement process, and evaluation of the measurement results in the acoustic measurement data program 230, the evaluation corresponding to the respective measurement, for example). Such interaction between control data program 220 and acoustic measurement data program 230 may be indicated by the control data interface 225. This control data interface 225 may also be used to transmit suitable measurement points for the public address system 100, for example positions in the auditorium 102 at which microphones 232 may be set up, as determined by the simulation data program 210, to the acoustic measurement data program 230. The simulation data program 210 may select these suitable measurement points on the basis of the transmitted measurement results 106 and transmit them to the control data program 220.

The simulation data program 210 may compare the measurement results 106 from the acoustic measurement data program 230 with its simulation results and take the comparison as a basis for selecting the suitable measurement points for the public address system 100. It may be thus possible for the simulation data program 210 to select, for further measurements (e.g., at a time after which first measurements are performed), merely such measurement points for which the measurement results 106 from the acoustic measurement data program 230 differs significantly from the simulation results from the simulation, for example, so as to reduce the number of possible measurement points and significantly shorten the measurement time.

The control data program 220 may be used to check correct operation of installation parts of the public address installation 104. The control data program may operate with network support, for example. Alternatively, the simulation data program 210 and the control data program 220 may be implemented as a cohesive program module.

The simulation data program 210 may be used as a standalone program module. The program may have a function of simulating a public address system 100, delivering configuration parameters 116 from the public address installation 104 in the public address system 100, and taking measurement results 106 from the public address installation 104 calibrated using the delivered configuration parameters 116 as a basis for customizing the simulation (e.g., by updating simulation parameters). The customization may reduce and/or compensate for a discrepancy between simulation results and measurement results 106 from the public address system 100. Therefore, it may be possible for the simulation to be performed more precisely than conventional simulations without evaluation of measurement results 106, for example. For this purpose, the simulation data program 210 may have an interface to the public address installation 104 suitable for transmitting the configuration parameters 116. By way of example, this interface may be implemented using a control data program 220 (e.g., as shown in FIG. 2). The simulation data program 210 may comprise an interface to the acoustic measurement data program 230 to receive the measurement results 106 in order to influence the simulation parameters and transmit information about suitable measurement points.

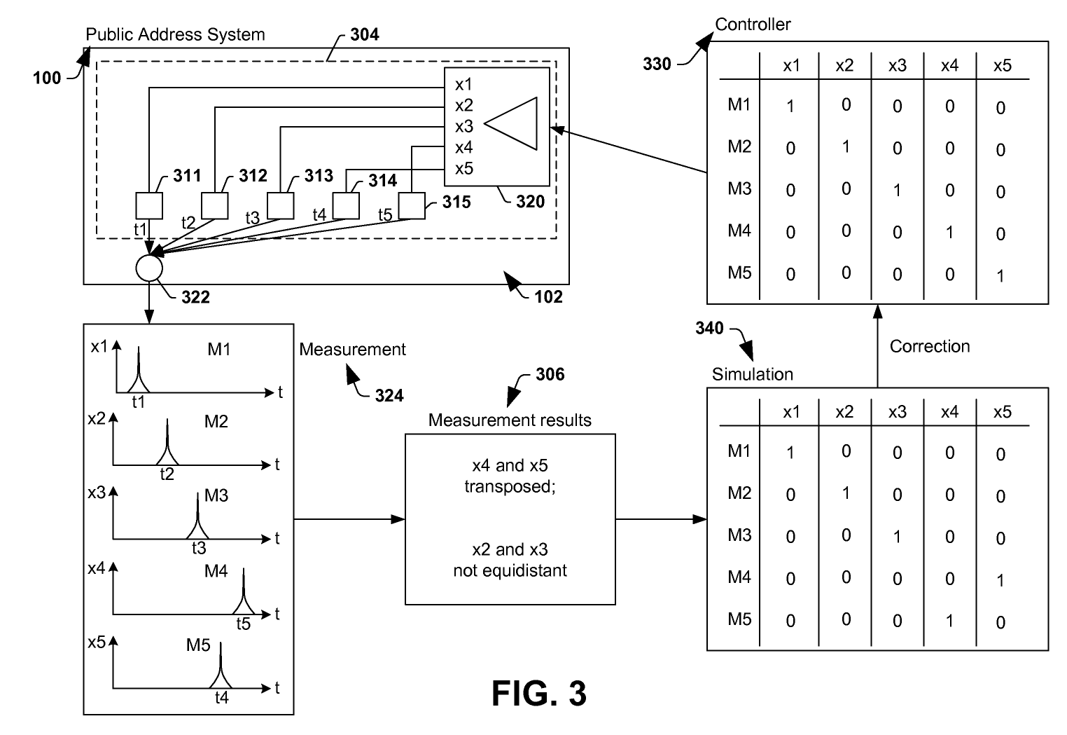

FIG. 3 illustrates a schematic illustration for calibrating a public address installation 304 comprising a subwoofer array in accordance with an exemplary embodiment. According to one embodiment, the public address system 100 may comprise a public address installation 304 having five bass loudspeakers (e.g., a subwoofer array) 311 to 315 and a five-channel amplifier 320, which may comprise five outputs x1 to x5 which may be respectively connected to a corresponding bass loudspeaker 311 to 315. To this end, the number of five has been chosen for illustrative purposes, other exemplary embodiments may comprise any integer number of bass loudspeakers 311 to 315 and/or channels x1 to x5, for example. In addition, the five outputs x1 to x5 may not be outputs of the same physical amplifier. For example, the outputs x1 to x4 on a four-channel amplifier A may be connected and the output x5 with further outputs x6 to x8 on a second four-channel amplifier B may be connected. The public address installation 304 may be set up in an auditorium 102, for example.

The subwoofer array may comprise a distributed arrangement of bass loudspeakers (e.g., sources). In one embodiment, the distributed arrangement may comprise between two and approximately twenty-five sources, for example. One purpose of such an arrangement is to distribute available bass energy over a defined audience area, (e.g., a part of the auditorium 102 in which the audience sits). For example, with typical live sound, the arrangement of the sources may be equidistant on a horizontal line in front of the stage. Small discrepancies in the distance between the sources and discrepancies in the horizontal line may not affect operation, for example. Thus, customization of positions to suit an available stage set may be possible, for example. Positioning and adjustments in the signal processing of the individual sources may be provided by the five-channel amplifier 320. Further, adjustments to the desired level distribution, may be simulated and/or optimized using appropriate software, for example.

One aspect for the desired operation provides that the signal processing for the actual position of the respective source may be applied. Further, the correct association (e.g., cabling) between the sources and associated intended amplifiers (e.g., amplifier channels) may be applied. A discrepancy between the actual position and the position used for the simulation is generally not a problem in principle, but it may be desirable to customize the signal processing to suit the relevant source(s), for example. The fast metrological ascertainment of actual positions of the sources, verification of the correct association with the relevant amplifier (e.g., amplifier channels), and intended signal processing for the individual sources, are illustrated below.

The distributed arrangement of bass loudspeakers may comprise a group of loudspeakers operated by a plurality of amplifier channels. For example, respective source positions may comprise a plurality of loudspeakers which form a functional group with appropriate (e.g., identical) signal processing.

The number of sources used and theoretical positions thereof may be received from the simulation. These positions may be used to ascertain and/or propose a suitable measurement point, for example. In one embodiment, a measurement point may be at a short distance front of a source at an edge of an array, for example. A measurement microphone 322 may be positioned at the measurement point, for example. The measurement of impulse responses (e.g., which may reveal an absolute signal propagation time from respective individual sources) may be performed automatically, for example. In one embodiment, the measurement of impulse responses may be managed by control data program 220. Control data program may manage removal of signal processing influencing propagation time within amplifier channels; switching on a first source; measurement; storage of the first measurement results; switching off the first source; switching on a second source; measurement; storage of the second measurement results; switching off the second source; etc. The original signal processing may be switched on when desirable, for example. Distances between the individual sources and the measurement positions may be determined based on absolute signal propagation times (e.g., assuming the speed of sound is known and constant). These distances for respective individual sources may be compared with the position data from the simulation, for example. Discrepancies may be communicated and/or corrected manually or automatically based on data transfer and/or a free coordinate calculation. The free coordinate calculation may be one proposed solution for the simulation parameters. By way of example, the positions may actually be on a line (e.g., a known coordinate) while discrepancies in the distance between respective sources may occur. These discrepancies may be adopted by the simulation data program 210 to correct the simulation parameters, for example. That is, for example, the simulation data program 210 may perform optimization of the signal processing of the individual sources to suit the actual positions and transmit the optimization to relevant amplifiers (e.g., amplifier channels). If an incorrect cabling is determined (e.g., respective individual sources and/or intended amplifier channels are transposed), the cabling may be corrected manually or the association of the amplifiers (e.g., amplifier channels) in the control software (e.g., control data program 220) may be corrected in accordance with the real cabling.

In the exemplary embodiment in FIG. 3, the calibration 324 may be performed using a microphone 322. In one exemplary embodiment, the microphone 322 may be set up close to the first bass loudspeaker 311 or may naturally be arranged at any other location in the auditorium 102 at which meaningful measurement results may be obtained. In one embodiment, measurement 324 may be coordinated by a controller 330, with five elemental measurements M1 to M5 being performed in succession, applying test signals to amplifier channels x1 to x5, respectively. For example, M1 may be the elemental measurement in which the bass loudspeaker 311 is intended to have a test signal “1” applied, M2 may be the elemental measurement in which the bass loudspeaker 312 is intended to have a test signal “1” applied, M3 may be the elemental measurement in which the bass loudspeaker 313 is intended to have a test signal “1” applied, M4 may be the elemental measurement in which the bass loudspeaker 314 is intended to have a test signal “1” applied, and M5 may be the element measurement in which the bass loudspeaker 315 is intended to have a test signal “1” applied. Respective element measurements M1 to M5, corresponding to the signal levels on the microphone 322, are illustrated as graphs in FIG. 3.

For example, the first elemental measurement M1, the distance between the first bass loudspeaker 311 and the microphone 322 is shortest, and after a time t1, the transmitted pulse “1” may arrive at the microphone and be recorded. For the second and third elemental measurements M2 and M3, the distances between loudspeakers 312, 313, and microphone 322 is greater, thus the transmitted pulses “1” may arrive at the microphone 322 at the times t2 and t3. For the fourth elemental measurement M4, the test signal “1” may arrive at the microphone 322 at a later time, at least because the fourth amplifier channel x4 may be (e.g., incorrectly) connected to the fifth bass loudspeaker 315, and thus has a greater distance to cover. To this end, for the fifth elemental measurement M5, the test signal “1” may not take as long to arrive at the microphone 322 as the fourth elemental measurement M4, at least because the fifth amplifier channel x5 may be (e.g., incorrectly) connected to the fourth bass loudspeaker 314. Therefore, connecting cables may be transposed between the fourth x4 and fifth x5 amplifier channels, for example. This cable transposition (e.g., error) may be determined based on measurement results 306. Additionally, an equidistance error (e.g., individual bass loudspeakers 311 to 315 may not be set up equidistantly) may be determined based on measurement results. Thus, the distance between the first 311 and second 312 loudspeakers may be greater and the distance between the second 312 and third 313 loudspeakers may be less than an average and/or target value. The controller 330 for the measurement process may be implemented in the control data program 220, for example.

When measurement results 306 are used for a fresh simulation 340, a cable transposition error may be corrected in the model of the public address system 100. The next measurement 324 may be driven such that the fourth elemental measurement M4 drives the fifth amplifier channel x5 (e.g., correctly driving the fourth bass loudspeaker 314), and that the fifth elemental measurement M5 drives the fourth amplifier channel x4, (e.g., correctly driving the fifth bass loudspeaker 314). The cable transposition error may therefore be compensated for by virtue of considerations based on cable connections in the simulation model.

By way of example, it may be possible to compensate for the equidistance error by correcting the positions used in the simulation for the bass loudspeakers 314 based on the measured values obtained (e.g., actual positions ascertained by measurement may be used as simulation parameters). Therefore, the simulation results provide approximates and identify discrepancies between the simulation results and measurement results in subsequent measurements to become smaller and at the same time more meaningful.

Additionally, a cable transposition error (e.g., transposed connecting cables) may comprise a polarity reversal error (polarities and/or connections such as “positive” and “negative” transposed) may be corrected.

In another embodiment, the subwoofer array may comprise a vertical line array. A vertical line array may comprise a number of loudspeaker cabinets are arranged directly beneath one another with few or no gaps. A desired radiation profile may be adjusted using a combination of mechanical angling and/or electrical driving of respective individual sources. For example, correct and/or desired operation may require a defined association between the individual sources/groups of sources and the amplifiers (e.g., amplifier channels). Similarly, for a subwoofer array, it may be possible for the correct association between the sources and the respective intended amplifiers to be checked and corrected. A suitable position for the measurement may be chosen such that explicit propagation times arise for (e.g., groups of) sources, for example. Such a suitable position may be ascertained from the simulation data. The fundamental procedure or the program sequence may be similar to FIG. 3.

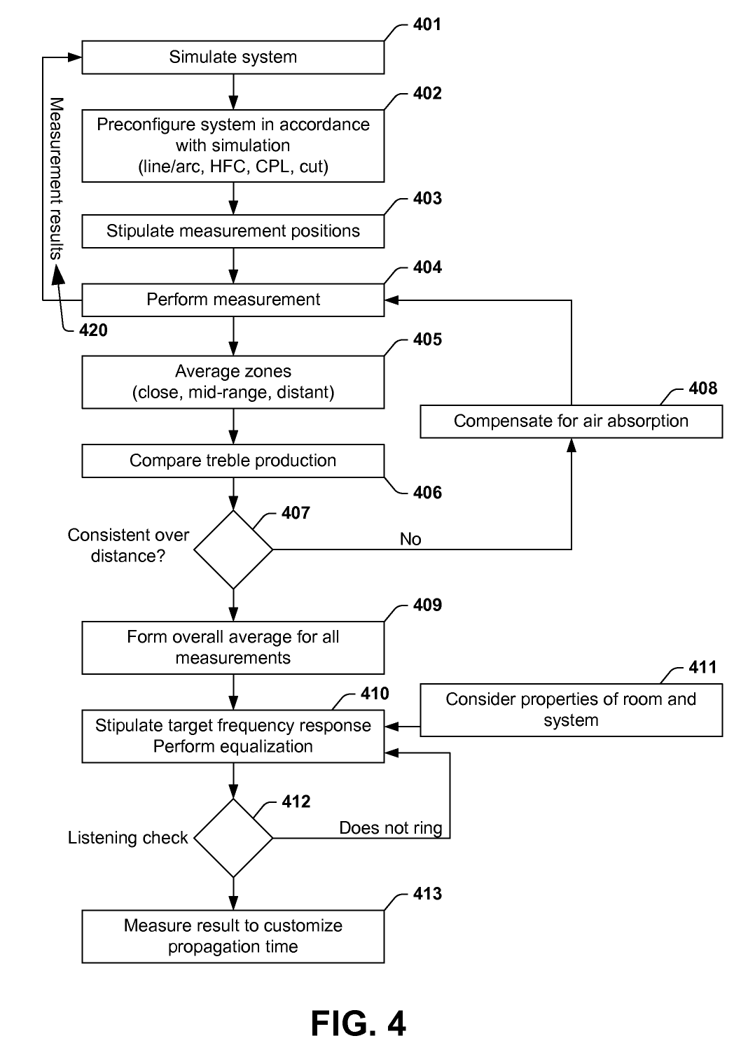

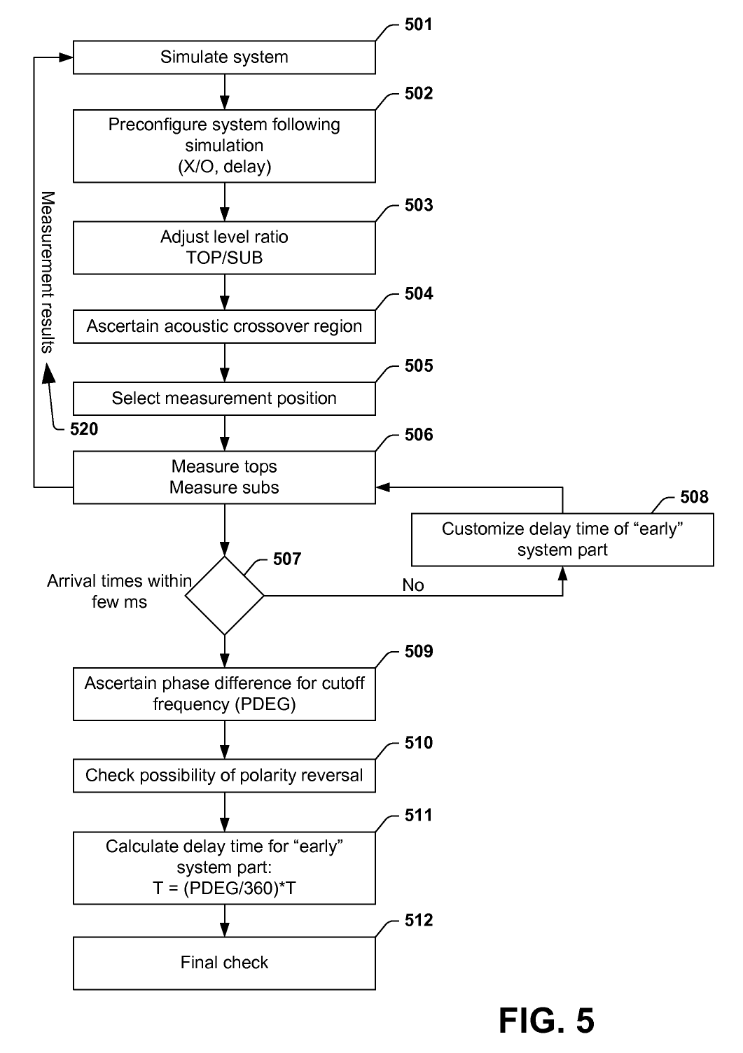

FIG. 4 illustrates a flow diagram for calibrating a public address installation for a frequency response optimization in accordance with an exemplary embodiment. FIGS. 4 and 5, (which are described below), use abbreviations “LINE”, “ARC”, “CPL”, “HFC”, “TOP”, “SUB”, “CUT” and “XO” or “X/O”, explained in greater detail herein.

“LINE” is a mode of operation which provides a compensating characteristic in order to obtain a linear frequency response. Depending on the length and curvature of a line array, the spectrally different summation of the individual sources, (e.g., of the cabinets in the array, produces a different overall frequency response at the listening position). As an example, this may mean that a straight array sums the frequencies to be transmitted with a (e.g., maximum) coherency at a listening position from a great distance, since the differences in the path lengths from the source to the listening position are generally small in comparison with the wavelengths of even the highest frequencies. When approaching this array, the path length differences enter the order of magnitude of the wavelengths of the highest frequencies of interest after a certain distance. It follows from this that the coherency may be traced back to the summation for these frequencies, at least because the level of the high frequencies becomes lower relative to the lower frequencies. Since the typical listening distance from a line array may be within this range, this response needs to be compensated for in order to obtain a linear frequency response. The compensating characteristic may be provided by the “LINE” mode of operation on the controller amplifier.

A similar effect may be observed when the array is curved. As another example, a listener in a target area of a curved array may merely hear the coherent sum of the sound levels from a small part of the array at higher frequencies whose wavelengths are in the region of the path length differences for adjacent sources, whereas he may hear the sum of the sound levels from almost the whole array at the same location at lower frequencies. The compensation may be provided by the “ARC” mode of operation.

Although the repercussions on the summed frequency response for these two effects are the same in principle, e.g., bass components may be more audible than treble components, the respective different geometric circumstances mean that the effects are very different on the frequency axis. Therefore, choice of mode of operation for the typical areas of an array (top: little to no curvature→LINE; bottom: high curvature→ARC) may result in a common manipulated variable “CPL” (abbreviation for “coupling”, acoustic coupling of the array) which may be applied to all driving controller amplifiers for an array and caters for largely consistent frequency responses in the target area.

The “HFC” (High Frequency Compensation) mode of operation provides typical standard compensation in multiple stages for the molecular absorption of the high frequencies in air for a distance defined for each stage for a stipulated (e.g., typical) temperature and humidity. Therefore, the standardized calculation of the absorption of sound by the air may be based on the “ISO 9613” standard.

“TOP” denotes a fully developed (e.g., “full range”) public address system, such as a wideband public address system and/or wideband loudspeaker system. The CUT function (e.g., low-cut), where the “CUT” stands for bass reduction, is used to reduce the sub-bass range, typically in the frequency range of <100 . . . 150 Hz, by means of high-pass filters in order to increase the control limit with wideband signals. Bass reduction may be achieved using a subwoofer system (e.g., a bass loudspeaker system, referred to as a “SUB”). A typical transmission range of a SUB system may be between approximately 30 to 40 Hz and approximately 100 to 150 Hz. Generally, public address systems may be split into TOPs and SUBs at the design stage.

“XO” may be an abbreviation for “crossover frequency”. Cutoff frequency is used to denote the resultant acoustic crossover frequency as the frequency above which the TOP loudspeaker reproduces the majority of the overall sound pressure level.

FIG. 4 illustrates a measurement procedure for the process of frequency response optimization. The system, (e.g., the public address system) may be simulated at 401. At 402, the system, (e.g., real public address system) may be preconfigured in accordance with the simulation. Configuration parameters may comprise “LINE/ARC”, “HFC”, “CPL” and “CUT”. At 403, measurement positions may be stipulated, and the measurement may be performed at 404. Measurement results 420 may be utilized in a (e.g., fresh) simulation at 401 in order to customize the simulation model to suit the real system ascertained by the measurement. At 401, a customized or corrected system may be determined and used to configure the real public address system at 402.

Following the stipulation of corrected measurement positions 403 and the measurement 404, zones of the auditorium may be averaged 405, for example by dividing the zones into the ranges, such as “near”, “midrange”, and/or “far”. In one embodiment, at 406, the treble reproduction may be compared. If the treble is not found 407 to be consistent over the distance, the absorption of the air may be compensated for at 408 and a fresh measurement taken at 404. If the treble reproduction is consistent over the distance, the overall average for measurements may be formed at 409, the target frequency response may be stipulated, and the equalization performed at 410. Further, at 411 the properties of the space and of the system may facilitate stipulating the frequency response and/or equalization 410. Finally, a listening check 412 may test whether the public address system sounds good, and if not, a fresh equalization may be performed 410. If the sound of the public address system is good, the result may be measured 413 for the purpose of propagation time customization.

Verification of the frequency response or of the equalizer settings primarily involves the frequency response of a complex array; the frequency response of a single loudspeaker, (e.g., one used without an array complex) is generally considered to be reasonable. The measurement of the frequency response of a whole array at suitable positions may be used to verify both the vertical overall orientation of the whole array and essentially the individual sources within a line array. Since every array produces characteristic different frequency responses depending on the configuration, (e.g., the number of single cabinets used and/or the angle thereof relative to one another), what is known as the splay angle, and the overall inclination at different positions in the target area, it is possible to verify the mechanical design, for example splay angle and overall inclination, using a match that has been found between simulation and reality (measurement) at a few positions. If a match is sufficiently exact, the complex measurement and averaging of a large number of different measurements can become unfounded. On the contrary, the resultant overall frequency response can be calculated for practically any number of listening positions, and the equalizer settings for the different target areas of the array parts can be calculated from the averaging of suitable subranges, the near range, the midrange, and the far range, respectively. Selection of suitable or representative points for actual measurements on the basis of experience therefore becomes unfounded.

Verification of the atmospheric parameters for the absorption of air is provided herein. Comparing a frequency response measurement at a known distance (e.g., example ascertainable from the signal propagation time) with the known frequency response of a loudspeaker at a reference distance, enables the actual frequency-dependent absorption per unit of distance to be determined. Simple optimization may be provided by varying the variables temperature and humidity to deliver effective values of the respective parameters. The calculation of the atmospheric absorption of sound may be standardized in ISO 9613-1.

FIG. 5 illustrates a flow diagram for calibrating a public address installation for propagation time customization in accordance with an exemplary embodiment. FIG. 5 illustrates a measurement procedure for the process of propagation time customization between subwoofer and main systems. The system (e.g., public address system) may be simulated at 501. At 502, the system, (e.g., real public address system) may be preconfigured in accordance with the simulation, for example. Configuration parameters may comprise “X/O” and/or “Delay”. At 503, the level ratio between the parameters “TOP” and “SUB” may be adjusted, and the acoustic crossover range may be determined at 504. Measurement positions may be selected at 505, and the tops and subs may be measured at 506. The measurement results 520 may be utilized in a fresh simulation at 501 in order to customize the simulation model to suit the real system ascertained by the measurement. A customized or corrected system may thus be determined at 501, and used to configure the real public address system at 502.

Following adjustment of the level ratio between TOP and SUB 503, the acoustic crossover range 504 may be determined, selection of the measurement position 505, and measurement 506 of the tops and subs, a check may be performed 507 to determine whether arrival times for the sound are within a millisecond range. The delay time or delay for the “early” system part may be customized 508 and then the tops and subs can be measured again 506. For example, if the arrival times are within a few milliseconds 507, the phase difference “pdeg” at the cutoff frequency can be ascertained 509. Additionally, polarity may be checked 510 and the delay time for the “early” system part may be calculated 511 (e.g., based on a formula t=(pdeg/360)*T), and a final check may be performed 512.

For a setup comprising a subwoofer array and a line array, the line array may be denoted as the main system. It may be possible to determine the time alignment (e.g., the time orientation between main system and subwoofer array and/or individual subwoofer). When the relative source positions are verified, (e.g., as described above), the correct time alignment may be determined for the respective positions (e.g., time orientation), from the simulation without further measurement for respective desired locations.

In another embodiment, an ancillary public address system may be setup (e.g., a fill system). By way of example, the fill system may provide near-field sound (e.g., areas under balconies, etc.). Generally, it may be desirable to obtain an efficient time coherency over an entire relevant radiation range of the fill systems. Generally, an optimum setup may not be possible for geometric reasons, and thus, compromises over the relevant ranges may be found. With knowledge of the spatial radiation characteristics, the approximate position and the direction of sound emission of the systems used, it may be possible to use an optimization routine in the simulation to prescribe a point or an axis for alignment to achieve the target criterion over the entire relevant range.

In another embodiment, a second and/or a plurality main system(s) may be setup. Generally, coverage of an arena or a stadium may comprise multiple main systems, since the horizontal radiation range of a main system or main array may not be sufficient for an angle range. Since the systems used generally drop quickly in level outside their nominal radiation angle, production of matching time coherency in the crossover range between two sources on the axis on which the two sources produce the same level may be desired. If, besides the orientation, the positions in the space are known an adjustment value may be calculated, for example. If the positions are known at least to the extent that small discrepancies to be expected do not give rise to the expectation of any significant level shifts, then it may be possible to propose a suitable measurement point at which an exact alignment may be set. If a measurement microphone is situated at a suitable location, the alignment process can then be performed automatically as follows: switch on reference system only; take reference measurement; switch on second system only; take second measurement. The difference in the measured arrival times results in the (e.g., additional) delay time.

In addition, while a particular feature or aspect of an embodiment may have been disclosed with respect to only one of several implementations, such feature or aspect may be combined with one or more other features or aspects of the other implementations as may be desired and advantageous for any given or particular application. This application is intended to cover any adaptations or variations of the specific embodiments discussed herein, and the subject matter herein is intended to be limited only by the claims and the equivalence thereof.

What is claimed is:

1. A method for calibrating a public address installation, comprising:
simulating a public address system based at least in part on one or more simulation parameters, the public address system comprising the public address installation and an auditorium;
delivering one or more configuration parameters for the public address installation;
configuring the public address installation based at least in part on at least some of the configuration parameters;
measuring one or more acoustic measurements in the auditorium; and
customizing at least some of the simulation parameters based at least in part on one or more measurement results.

2. The method of claim 1, customizing at least some of the simulation parameters comprising delivering one or more new configuration parameters in a fresh simulation based at least in part on at least some of the customized simulation parameters, at least some of the new configuration parameters configured to improve a match between one or more simulation results and at least some of the measurement results.

3. The method of claim 1, at least some of the simulation parameters comprising dimensions of the auditorium, spatial configuration data, or sonic configuration data associated with the public address installation.

4. The method of claim 1, at least some of the measurement results comprising a propagation delay, a frequency-dependent level distribution, an impulse response, a frequency response, a reverberation response, or an intelligibility measure associated with the auditorium.

5. The method of claim 1, the public address installation configured to change installation settings.

6. The method of claim 1, the public address installation comprising an arrangement of one or more bass loudspeakers, respective loudspeakers associated with an amplifier channel comprising:
choosing a suitable measurement point;
operating the public address installation by sequentially driving the individual bass loudspeakers and measuring associated sound propagation times;
determining distances from the respective bass loudspeakers to the chosen measurement point based at least in part on the measured sound propagation times; and
adjusting at least some of the simulation parameters to match at least some of the determined distances.

7. The method of claim 6, the arrangement comprising one or more functional groups, respective functional groups using a same signal processing.

8. The method of claim 1, the public address installation comprising a vertical line array comprising one or more sound sources, a radiation profile for the line array based at least in part on positioning of one or more sound sources relative to one or more other sound sources and the electrical driving of at least some of the sound sources, comprising:
choosing a suitable measurement point;
operating the public address installation by sequentially driving at least some of the sound sources of the line array and measuring associated sound propagation times; and
adjusting at least some of the simulation parameters to match the positioning of at least some of the sound sources.

9. The method of claim 1, comprising adjusting coefficients for an equalizer based at least in part on at least some of the configuration parameters.

10. The method of claim 1, the public address installation comprising a loudspeaker array driven via an equalizer, comprising:
choosing a suitable measurement point;
measuring a frequency response for the loudspeaker array based at least in part on the measurement point; and
verifying a mechanical design of the loudspeaker array based at least in part on a comparison of the measured frequency response and a simulated frequency response.

11. The method of claim 10, adjusting the equalizer based at least in part on a discrepancy between the measured frequency response and the simulated frequency response.

12. The method of claim 10, comprising:
determining a time alignment between one or more loudspeakers of the loudspeaker array for a location in the auditorium.

13. The method of claim 10, comprising:
determining an air absorption based at least in part on a comparison of the measured frequency response with a known reference frequency response.

14. A computer-readable storage medium comprising computer-executable instructions, which when executed at least in part via a processing unit on a computer performs acts, comprising:
delivering one or more configuration parameters for a public address installation;
configuring the public address installation based at least in part on at least some of the configuration parameters;
measuring one or more acoustic measurements in the auditorium; and
customizing at least some of the simulation parameters based at least in part on one or more measurement results.

15. The computer-readable storage medium of claim 14, customizing at least some of the simulation parameters comprising delivering one or more new configuration parameters in a fresh simulation based at least in part on at least some of the customized simulation parameters, at least some of the new configuration parameters configured to improve a match between one or more simulation results and at least some of the measurement results.

16. The computer-readable storage medium of claim 14, at least some of the simulation parameters comprising dimensions of the auditorium, spatial configuration data, or sonic configuration data associated with the public address installation.

17. The computer-readable storage medium of claim 14, at least some of the measurement results comprising a propagation delay, a frequency-dependent level distribution, an impulse response, a frequency response, a reverberation response, or an intelligibility measure associated with the auditorium.

18. The computer-readable storage medium of claim 17, the public address installation configured to change installation settings.

19. A system for calibrating a public address installation, comprising:
a simulation component configured to:
simulate a public address system based at least in part on one or more simulation parameters, the public address system comprising the public address installation and an auditorium;
deliver one or more configuration parameters for the public address installation;
configure the public address installation based at least in part on at least some of the configuration parameters;
measure one or more acoustic measurements in the auditorium; and
customize at least some of the simulation parameters based at least in part on one or more measurement results.

20. The system of claim 19, at least some of the simulation parameters comprising dimensions of the auditorium, spatial configuration data, or sonic configuration data associated with the public address installation.
